(19) United States
(12) Patent Application Publication
(10) Pub. No.: US 2024/0397557 A1
(43) Pub. Date: Nov. 28, 2024

(54) OVERFLOW AND RECONFIGURATION OF RANDOM-ACCESS CHANNEL OCCASIONS

(71) Applicant: ZTE CORPORATION, Shenzhen, Guangdong (CN)

(72) Inventors: Juan LIU, Shenzhen (CN); Li TIAN, Shenzhen (CN); Ziyang LI, Shenzhen (CN)

(21) Appl. No.: 18/696,071

(22) PCT Filed: Sep. 29, 2021
(86) PCT No.: PCT/CN2021/121575

§ 371 Date: Mar. 27, 2024

(51) Int. Cl. H04W 74/0833; H04W 72/0446

(52) U.S. Cl. CPC H04W 74/0833; H04W 72/0446

(57) ABSTRACT

A method performed by a wireless terminal device is provided, and the method performed by a wireless terminal device includes: receiving a physical random-access channel (PRACH) configuration information from a base station or wireless access node, the PRACH configuration information indicating a PRACH time slot and intra-time-slot symbol positions of a plurality of PRACH occasions within the PRACH time slot for transmitting a random-access preamble, identifying at least one target time slot; relocating at least one of the plurality of PRACH occasions to the at least one target time slot.

### CROSS-REFERENCE TO RELATED APPLICATION(S)

This application is a national phase entry under 35 USC 371 of International Patent Application No. PCT/CN2021/121575 filed on Sep. 29, 2021, and the entire content of the International Patent Application is incorporated into this application for reference.

### TECHNICAL FIELD

This disclosure is directed generally to wireless access communication networks and particularly to cross-time-slot overflow and reconfiguration of random-access channel occasions.

### BACKGROUND

In wireless access networks, multiple terminal devices may share radio communication resources via random-access procedures to communicate with a wireless access network node. The shared radio resources allocated for performing random access may be configured and signaled via various control channels or messages. Prior allocated radio resources for random access may become unattainable in some circumstances. A procedure and corresponding protocol rules for substituting, relocating, or reconfiguring such radio resources may be designed in order to maintain a smooth random-access operation.

### SUMMARY

This disclosure relates to methods, systems, and devices for cross-time-slot overflow and reconfiguration of radio resources for random-access channel occasions.

In one embodiment, a user equipment is disclosed. The UE may be configured to receive a PRACH configuration information from a base station or wireless access node. The PRACH configuration information may indicate a PRACH time slot and intra-time-slot symbol positions of a plurality of PRACH occasions within the PRACH time slot for transmitting a random-access preamble. The UE may be configured to further identify a target time slot according to, for example, a location of the PRACH time slot and a target time slot configuration rule set and relocating at least one of the plurality of PRACH occasions of the PRACH time slot to the target time slot.

In another embodiment, a wireless access node or a base station is disclosed. The wireless access node or a base station may be configured to transmit PRACH configuration information to a wireless terminal device. The PRACH configuration information may indicate a PRACH time-slot and intra-time-slot symbol positions of a plurality of RACH occasions within a PRACH time slot corresponding to the PRACH time-slot position for transmitting a random-access preamble. The wireless access node or a base station may be configured to further identify an overflow condition of PRACH occasions. For a relocation of overflow PRACH occasions, the wireless access node or a base station may further identify a target time slot according to, for example, a location of the PRACH time slot and a target time slot configuration rule set, and identify a target symbol position within the target time slot according to, for example, the intra-time-slot symbol positions. The wireless access node or a base station may be additionally configured to receive a PRACH preamble from the wireless terminal device over the target symbol position in the target time slot under the overflow condition.

In another embodiment, a wireless device comprising a processor and a memory is disclosed. The processor may be configured to read computer code from the memory to implement any of the methods above.

In yet another embodiment, a computer program product comprising a non-transitory computer-readable program medium with computer code stored thereupon is disclosed. The computer code, when executed by a processor, may cause the processor to implement any one of the methods above.

The above embodiments and other aspects and alternatives of their implementations are described in greater detail in the drawings, the descriptions, and the claims below.

### BRIEF DESCRIPTION OF THE DRAWINGS

FIG. 1 illustrates an example wireless communication network comprising a wireless access network, a core network, and data networks.

FIG. 2 illustrates an example wireless access network including a plurality of mobile terminal devices and a wireless access network node in communication with one another via an over-the-air communication interface.

FIG. 3 illustrates an example wireless communication resource grid in both the time domain and frequency domain.

FIG. 4 illustrates an example allocation of random-access occasions in a random-access time slot without time gap.

FIG. 5 illustrates another example allocation of random-access occasions in a random-access time slot without time gap.

FIG. 6 illustrates an example allocation of random-access occasions in a random-access time slot with time gap.

FIG. 7 illustrates another example allocation of random-access occasions in a random-access time slot with time gap.

FIG. 8 illustrates an example configuration of time slots for overflowing random-access occasions.

FIG. 9 illustrates another example configuration of time slots for overflowing random-access occasions.

FIG. 10 illustrates yet another example configuration of time slots for overflowing random-access occasions.

FIGS. 11-16 illustrate various examples of time symbol configuration in a target time slot for overflowing random-access occasions.

### DETAILED DESCRIPTION

The technology and examples of implementations and/or embodiments described in this disclosure can be used for radio resource reconfiguration to facilitate a smooth random-access operation in a wireless access network. The term “exemplary” is used to mean “an example of” and unless otherwise stated, does not imply an ideal or preferred example, implementation, or embodiment. Section headers are used in the present disclosure to facilitate understanding of the disclosed implementations and are not intended to limit the disclosed technology in the sections only to the corresponding section. The disclosed implementations may be further embodied in a variety of different forms and, therefore, the scope of this disclosure or claimed subject matter is intended to be construed as not being limited to any of the embodiments set forth below. The various implementations may be embodied as methods, devices, components, systems, or non-transitory computer readable media. Accordingly, embodiments of this disclosure may, for example, take the form of hardware, software, firmware or any combination thereof.

This disclosure is directed to methods, systems, and devices related to cross-time-slot overflow and reconfiguration of radio resources for random-access channel occasions and rules thereof. While this disclosure provides example implementations in some particular generations of cellular network system, the underlying principles are applicable to other generations of cellular network systems and other general non-cellular wireless network systems.

### Wireless Network Overview

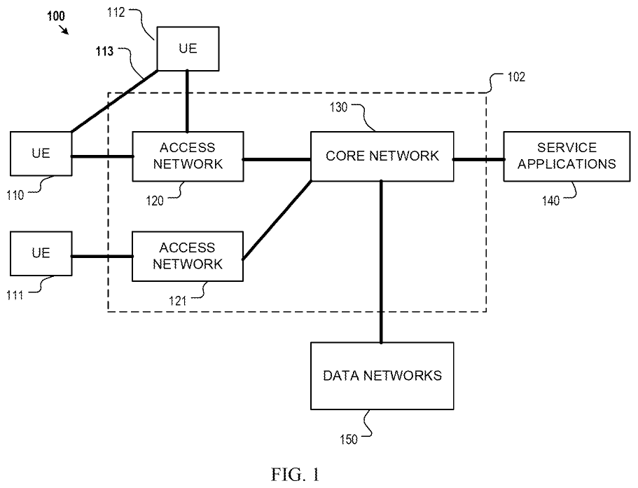

An example wireless communication network, shown as 100 in FIG. 1, may include user equipment (UEs) 110, 111, and 112, a carrier network 102, various service applications 140, and other data networks 150. The carrier network 102, for example, may include access networks 120 and 121, and a core network 130. The carrier network 102 may be configured to transmit voice, data, and other information (collectively referred to as data traffic) among UEs 110, 111, and 112, between the UEs and the service applications 140, or between the UEs and the other data networks 150. The Access networks 120 and 121 may be configured as various wireless access network nodes (WANNs, alternatively referred to as base stations) to interact with the UEs on one side of a communication session and the core network 130 on the other. The core network 130 may include various network nodes configured to control communication sessions and perform network access management and traffic routing. The service applications 140 may be hosted by various application servers deployed outside of but connected to the core network 130. Likewise, the other data networks 150 may also be connected to the core network 130.

In the wireless communication network of 100 of FIG. 1, the UEs may communicate with one another via the wireless access network. For example, UE 110 and 112 may be connected to and communicate via the same access network 120. The UEs may communicate with one another via both the access networks and the core network. For example, UE 110 may be connected to the access network 120 whereas UE 111 may be connected to the access network 121, and as such, the UE 110 and UE 111 may communicate to one another via the access network 120 and 121, and the core network 130. The UEs may further communicate with the service applications 140 and the data networks 150 via the core network 130. Further, the UEs may communicate to one another directly via side link communications, as shown by 113.

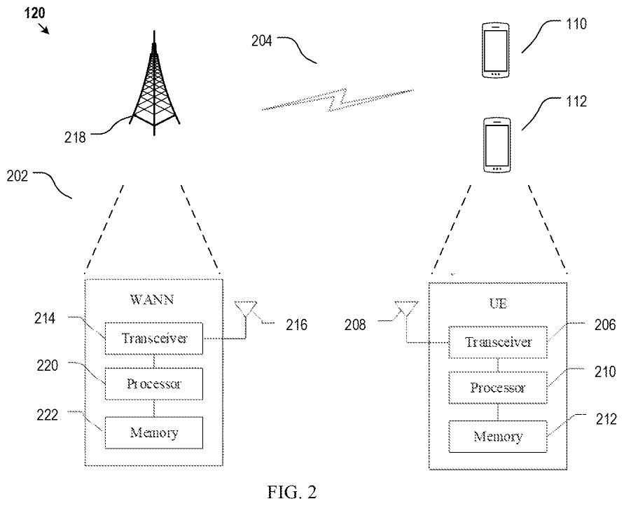

FIG. 2 further shows an example system diagram of the wireless access network 120 including a WANN 202 serving UEs 110 and 112 via the over-the-air interface 204. Each of the UEs 110 and 112 may be a mobile or a fixed terminal device installed with wireless access units such as SIM/USIM modules for accessing the wireless communication network 100. The UEs 110 and 112 may be implemented as a terminal device including but not limited to a mobile phone, a smartphone, a tablet, a laptop computer, a vehicle on-board communication equipment, a roadside communication equipment, a sensor device, a smart appliance (such as a television, a refrigerator, and an oven), or other devices that are capable of communicating wirelessly over a network. As shown in FIG. 2, each of the UEs such as UE 112 may include a transceiver circuitry 206 (also referred to as a transceiver 206) coupled to one or more antennas 208 to effectuate wireless communication with the WANN 202 or with another UE such as UE 110. The transceiver circuitry 206 may also be coupled to a processor 210, which may also be coupled to a memory 212 or other storage devices. The memory 212 may be transitory or non-transitory and may store therein computer instructions or code which, when read and executed by the processor 210, cause the processor 210 to implement various ones of the methods described herein.

Similarly, the WANN 202 may include a base station or other wireless network access point capable of communicating wirelessly via the over-the-air interface 204 with one or more UEs and communicating with the core network 130 using other appropriate communication interfaces. For example, the WANN 202 may be implemented, without being limited, in the form of a 2G base station, a 3G nodeB, an LTE eNB, a 4G LTE base station, a 5G NR base station, a 5G central-unit base station, or a 5G distributed-unit base station. Each type of these WANNs may be configured to perform a corresponding set of wireless network functions. The WANN 202 may include transceiver circuitry 214 (also referred to as a transceiver 214) coupled to one or more antennas 216, which may include an antenna tower 218 in various forms, to effectuate wireless communications with the UEs 110 and 112. The transceiver circuitry 214 may be coupled to one or more processors 220, which may further be coupled to a memory 222 or other storage devices. The memory 222 may be transitory or non-transitory and may store therein instructions or code that, when read and executed by the processor 220, cause the processor 220 to implement various functions of the WANN 202 described herein.

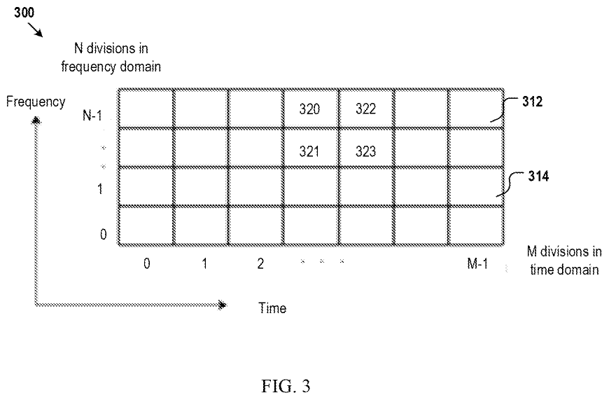

The wireless transmission resources for the over-the-air interface 204 include frequency, time, and spatial resource. For example, the frequency and time resource available for wireless communication (alternatively referred to as wireless resource, or wireless transmission resource) is illustrated as 300 in FIG. 3. The transmission resource 300 (hereinafter also referred to as a wireless resource 300 or a time and frequency resource 300) includes time domain resource and frequency domain resource that may be allocated to carry downlink or uplink data or control information. The transmission resource 300 may be further divided into multiple divisions to support more flexible transmission resource scheduling, configuration, and allocation. For example, in the time domain, the transmission resource 300 may be divided into M divisions, and in the frequency domain, the transmission resource 300 may be divided into N divisions. As such, the transmission resource 300 may be considered as a resource grid including M*N resource divisions. M and N are both positive integers. In FIGS. 3, 312 and 314 are shown as two example divisions. Organization of the transmission resource 300 into resource divisions of FIG. 3 facilitates more efficient resource allocation, configuration, and utilization.

The division of time and frequency of wireless resource 300 may be made at various hierarchical levels. FIG. 3 merely shows an example division at a particular level. The configuration and identification of the time and frequency resource may be made at any level. For example, the wireless resource 300 may be divided into resource blocks (RBs), representing the smallest unit of wireless resource allocable to a UE for communication with a WANN. Each RB may be further divided into sub-units in both time and frequency that are separately identifiable and configurable. For example, in the frequency domain, an RB may be divided into a configurable number of subcarriers having a configurable subcarrier spacing. In the time domain, an RB may occupy a time slot with a configurable time length that may be further divided into a number of time units each corresponding to, for example, a symbol in orthogonal frequency division multiplexing (OFDM) or other modulation schemes. Each unit containing a subcarrier in the frequency domain and a symbol in the time domain may be referred to as a resource element (RE), representing the smallest unit of the wireless resource 300 that is identifiable, allocable, and configurable. The wireless resource 300 may be allocated and configured in higher levels. For example, in the time domain, a sub-frame may include a predetermined number (e.g., 7) of time slots, a frame may include a predetermined number (e.g., 2) of sub-frames. For another example, blocks of subcarriers in a number of RBs in the frequency domain may be organized as various frequency channels, each allocated for different purposes in transmitting data and control information. These frequency channels may include but are not limited to uplink frequency channels (such as physical uplink shared channels (PUSCHs), physical uplink control channels (PUCCHs), and the like) and downlink frequency channels (such as physical downlink shared channels (PDSCHs), physical downlink control channels (PDCCHs), and the like). While the term “frequency channel” is used to refer to the collection of subcarriers in a particular frequency range, the term “channel” by itself may be used to refer to the broader concept of resource units not limited to the frequency domain.

While the description above focuses on time and frequency resource 300, it may be combined with spatial multiplexing based on utilizing multiple antennas and beam forming in wireless transmission. The allocation and configuration of such spatial resources may be part of the overall wireless resource allocation and configuration. The principles underlying the various implementations included in this disclosure are intended to be applicable to wireless resource allocation and configuration including all of time, frequency, and space dimensions.

### Random Access and Random-Access Occasions

Returning to FIG. 2, in many circumstances, a user equipment may request access to over-the-air radio communication resources at random times and as needed, particularly for user equipment that are not data intensive. Random-access channel resources may be made available and assigned by the WANNs upon a random-access request by the UE. In some implementations, requests for random access by the UE may be transmitted to a WANN in the form of a random-access preamble. The WANN, upon receiving the random-access preamble, may then allocate physical communication resources in accordance with the preamble for use by the UE to transmitting data. The physical radio resources over which a random-access preamble is transmitted may be pre-configured. Such pre-configured radio resources may be referred to as random-access occasions. Each random-access occasion may occupy a particular radio resource unit in the allocated resource grid shown in FIG. 3. For example, each random-access occasion may occupy one or more REs, where each RE comprises one or more (e.g., 2) symbols in the time domain and one subcarrier in the frequency domain.

Pre-configuration of the random-access occasions for the UE over which random-access request or preamble is communicated may be transmitted as a random-access configuration message from the WANN to the UE. Such a random-access configuration message, for example, may be included in a higher layer control message or signaling. In some implementations, random-access occasions may be allocated/configured as a pattern with repeating REs in the resource grid. For example, they may occupy a particular set of subcarriers in frequency and may periodically occur in the time domain. The allocation/configuration of these random-access occasions may be specified in the random-access configuration message using, for example, an index among a group of predefined indices. Such an index may be referred to as a physical random-access channel configuration index (or “PRACH configuration index”). Each index of the group of predefined PRACH configuration indices may be mapped to locations of REs in the resource grid corresponding to a particular set of REs that are allocated as random-access occasions. Upon receiving the random-access configuration message, the UE may extract the PRACH configuration index from the message and determine the locations of the random-access occasions that are allocated and configured for transmission random-access preambles.

An example of a mapping table between a group of predefined PRACH configuration indices and configuration parameters random-access occasions are shown below:

| | | | | Nₜ^{RA, slot}, | |
|---|---|---|---|---|---|
| | | | | Number | |
| | | | | of Time- | |
| | | | Number of | Domain | |
| | | Starting | PRACH | PRACH | |
| | | Symbol | Time Slots | Occasions | |
| PRACH | | Position | within | within | N_{dur}^{RA}, |
| Config. | Slot | Relative to | a 60 KHz | PRACH | PRACH |
| Indices | Number | a Time Slot | Time Slot | Time Slot | Duration |
| 12 | 19, 39 | 7 | 1 | 3 | 2 |
| 89 | 4, 9, 14, | 2 | 2 | 6 | 2 |
| | 19, 24, 29, | | | | |
| | 34, 39 | | | | |
| 98 | 9, 19, 29, 39 | 8 | 2 | 3 | 2 |
| 228 | 9, 19, 29, 39 | 6 | 1 | 2 | 4 |

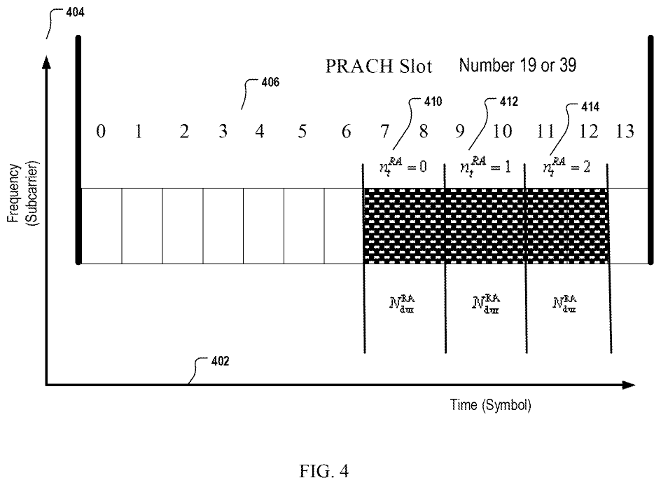

This example mapping specifies a correspondence between the set of predefined PRACH configuration indices and a set of parameters that indicate locations of radio resource elements configured and allocated for random-access occasions. For example, PRACH index “12” corresponds to resource element locations as indicated in the first mapping row above and as illustrated in FIG. 4 showing random-access occasion allocation 400 in time domain 402 for a particular allocated subcarrier in frequency domain 404. As shown in FIG. 4, three (3, as indicated by the Nₜ^{RA,slot} parameter in the mapping table) random-access occasions 410, 412, and 414 are allocated in time slots having slot number 19 and 39 (as indicated by the “slot number” parameter column in the mapping table above) under PRACH configuration index 12. A time slot, such as time slot number 19 and 39, may include a predetermined number of symbols (e.g., 14 orthogonal frequency division multiplexing (OFDM) symbols, with symbol index from 0 to 13), as shown by 406. Each random-access occasion of the three random access occasions 410, 412, and 414 occupies two (2) symbols, with their locations specified by the N_{dur}^{RA}. (PRACH duration) parameters in the mapping table above for PRACH index 12. In this example, the three random-access occasions occupy a consecutive 6 symbols in each of slot #19 and #39 (3 random-access occasions multiplied by 2 symbols each), beginning at symbol index 7, as specified by the parameter “Starting Symbol Position Relative to a Time Slot” in the mapping table above for PRACH index 12. These three random-access occasions are numbered or indexed using the nₜ^{RA} shown in FIGS. 4, as 0, 1, and 2.

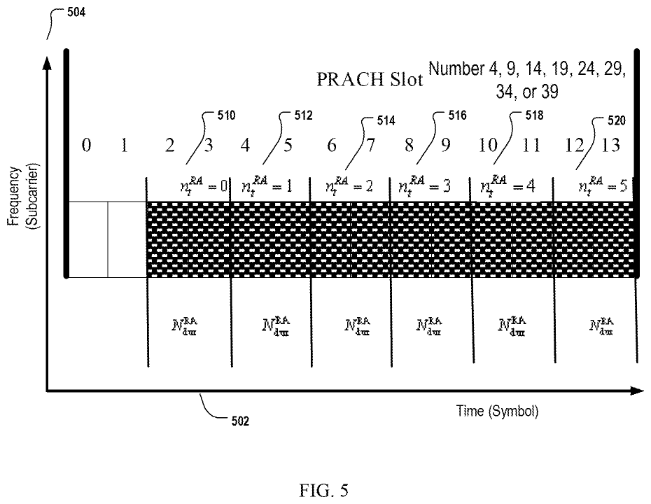

For another example, PRACH index “89” corresponds to resource element locations as indicated in the second row in the mapping table above and as illustrated in FIG. 5 showing random-access occasion allocation 500 in time domain 502 for a particular allocated subcarrier in frequency domain 504. As shown in FIG. 5, six (6) random-access occasions 510, 512, 514, 516, 518, and 520 are allocated in time slots having slot number 4, 9, 14, 19, 24, 29, 34, and 39 (as indicated by the “slot number” parameter in the mapping table above) under PRACH configuration index 89. Each random-access occasion of the six random access occasions 510, 512, 514, 516, 518, and 520 occupies two (2) symbols, as specified by the N_{dur}^{RA}. (PRACH duration) parameters for PRACH index 89 in the mapping table above. In this example, the six random-access occasions occupy a consecutive 12 symbols in each of the allocated time slot (6 random-access occasions multiplied by 2 symbols each), beginning at symbol index 2, as specified by the parameter “Starting Symbol Position Relative to a Time Slot” in the mapping table above for PRACH index 89. These six random-access occasions are consecutively numbered or indexed using the nₜ^{RA} shown in FIG. 5, as from 0 to 5.

Further in the mapping table above, the column labeled as “Number of PRACH Time Slots within a 60 KHz Time Slot” represents a constraint on a number of PRACH time slots within a reference time duration corresponding to a reference time slot for 60 kHz subcarrier spacing (SCS). Larger SCS corresponds to shorter time slot duration. For example, for a 480 KHz SCS, there are 8 time slots for each reference duration whereas for a 960 KHz SCS, there are 16 time slots for each reference duration. The “Number of PRACH Time Slots within a 60 KHz Time Slot” parameter of the mapping table specifies the number of PRACH time slots in 8 time slots for 480 kHz SCS and in 16 time slots for 960 KHz SCS.

The mapping table above is merely illustrated as an example. In practical implementations, a much larger number of PRACH indices may be included. As such, the mapping table above may contain a greater number of rows.

### Consequence of Configuration of Time Gap Between Random-Access Occasions

In situations in which high carrier frequencies are used, larger subcarrier spacing may be preferably introduced. To optimize system performance, it may not be desirable to have consecutive random-access occasions in an allocated random-access time slot. A time gap may be introduced between neighboring random-access occasions. A gap may be one or more symbols in length. Such time gaps may be used for purposes such as performing Listen-Before-Talk (LBT), beam switching, and/or other procedures and functions in-between random-access occasions. When such gaps are introduced, the random-access occasion locations following the specification of the mapping table above may be different from those without gaps (such as the random-access occasion locations illustrated in FIG. 4 and FIG. 5).

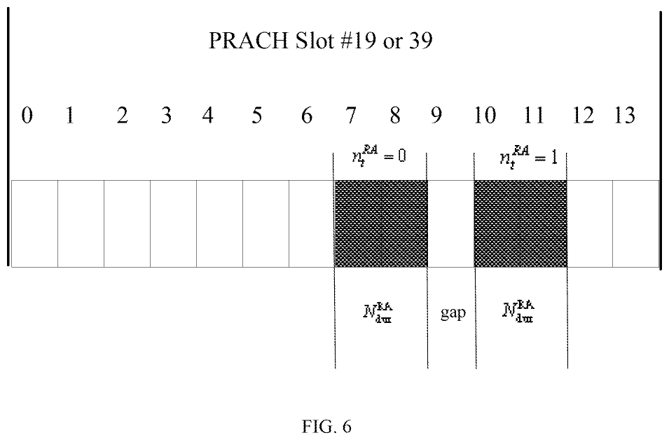

As an example, FIG. 6 shows the random-access occasion locations with one-symbol gaps for PRACH index 12 following the corresponding parameters specified in the example mapping table. FIG. 6 shows that, as the random-access occasions start at symbol #7 according to the mapping table and that one-symbol gap need to be inserted in between the random-access occasions, only 2 random-access occasions (with nₜ^{RA}=0 and 1) each having duration of 2 symbols rather than all 3 random-access occasions as specified by the mapping table may fit within the time slot #19 or 39 configured for random access occasions under PRACH index 12 within the end of that time slot.

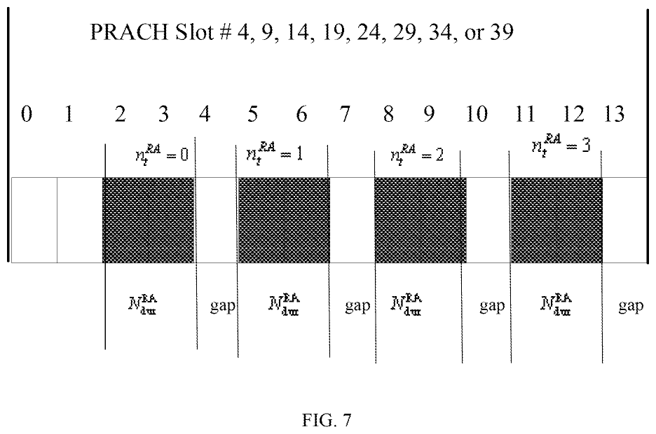

Likewise, FIG. 7 shows the random-access occasion locations with one-symbol gaps for PRACH index 89 following the corresponding parameters specified in the example mapping table. FIG. 7 shows that, as the random-access occasions start at symbol #2 according to the mapping table and that one-symbol gap need to be inserted in-between the random-access occasions, only 4 random-access occasions (with nₜ^{RA}=0, . . . , 3) each having duration of 2 symbols rather than all 6 random-access occasions as specified by the mapping table may fit within an allocated time slot configured for random access occasions under PRACH index 89 within the end of that time slot.

While the single-symbol gaps are described in the example above, in some implementations, the inserted time gaps may occupy more than one symbol. The underlying principles in the various implementations below are applicable to longer inter random-access occasion time gaps.

### Cross-Time-Slot Extension of Random-Access Occasions and Rule Set for Determining Target Time Slots for Overflow Random-Access Occasions

When not all of the random-access occasions specified in the predefined mapping able for an allocated time slot can fit within the configured random-access time slot (alternatively referred to as PRACH time slot), at least one of these random-access occasions may be relocated or reconfigured to another time slot (alternatively referred to as target time slot) according to some example implementations. The target time slot, for example, may be selected according to a target time slot selection rule set from time slots that are not originally configured by the mapping table above to carry any random-access occasions. In such a manner, rather than modifying the mapping table above, the target time slot selection rules or rule set may be specified and agreed upon for relocating or reconfiguring the overflowing random-access occasions as a result of time gap insertion in the configured random-access time slot. The target time slot location may be alternatively configured or signaled via other configuration message or signaling information. In some implementations, more than one target time slots may be specified for each PRACH time slot.

The target time slot selection rule set may be designed in various manners. The implementations described below are merely examples intended for illustration purposes. In one such example, with time gaps added to the PRACH time slot causing an overflow of random-access occasions for any PRACH configuration index, the target time slot for relocating or reconfiguring the overflowing random-access occasions may be specified as one of the uplink time slots contained in a reference time duration corresponding to a time duration of a reference time slot using a reference subcarrier spacing (SCS). The reference time slot and reference time duration may, for example, correspond to time slot of a reference SCS of, e.g., 60 KHz. A PRACH time slot corresponding to 60 KHz SCS may be referred to as a reference PRACH time slot. As such, when 480 KHz SCS rather than 60 KHz SCS is used in higher frequency bands, a reference time duration would encompass 8 actual time slots. Under this example rule set, candidate time slots for the target time slot for PRACH overflow may be then specified as N (an integer equal to or greater than 1) uplink time slots among the 8 actual times slots {0}, {2}, {1}, {3}, {4}, {5}, {6}, or {7} within the reference duration from the current PRACH time slot or that contains the current PRACH time slot. When the reference duration encompasses the PRACH time slot, then N time slots among the 8 time slots other than the PRACH time slot may be used as the candidate time slots for the target time slot. For another example, when 960 kHz SCS is used, a reference time duration would contain 16 actual time slots. Candidate time slots for the target time slot for PRACH overflow may be specified as N uplink time slots among the 16 actual times slots {0}, {1}, {2}, {3}, {4}, {5}, {6}, {7}, {8}, {9}, {10}, {11}, {12}, {13}, {14}, or {15} within the reference duration from the current PRACH time slot or that contains the current PRACH time slot. Again, when the reference duration encompasses the PRACH time slot, then N time slots among the 16 time slots other than the PRACH time slot may be used as the candidate time slots for the target time slot. The principles above are applicable to other actual SCSs. Specification of the which N time slots with the reference time duration as the candidate target time slots may be either predetermined (by default) or may be configured using explicit or implicit configuration messages or signaling information.

The number of candidate target time slots, N, can be 1, or can be larger than 1. When multiple candidate target time slots are configured for a PRACH time slot in the reference time duration, they may each be further associated with a priority level. Such priority level may be predetermined or configured (e.g., via separate configuration messages or signaling). Such priority indicates a rank or order in which the candidate target time slots are considered when handling overflow PRACH occasions. For example, two candidate target time slots {A} ad {B} within the reference time period may be specified with {A} having higher priority than {B}. When there is overflow of PRACH occasions (such that the PRACH time slot is not sufficient to hold all the PRACH occasions configured by the mapping table above), {A} is first considered for holding at least some of the over flow PRACH occasions because of its higher priority. {B} is further used when {A} does not have sufficient time spaces (for PRACH occasions by default or by configuration) for placing the overflow PRACH.

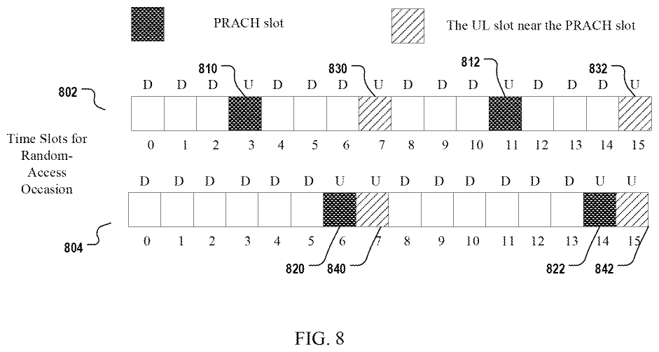

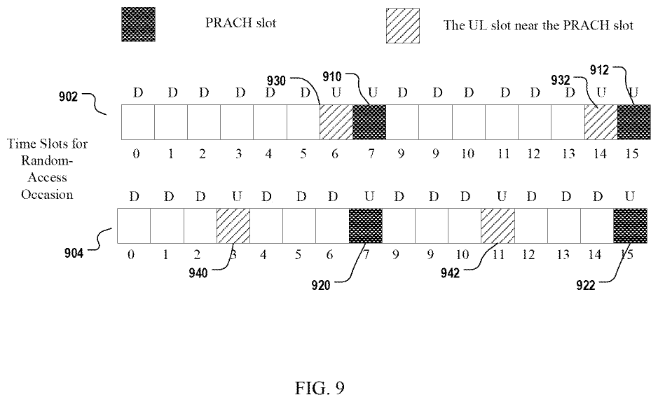

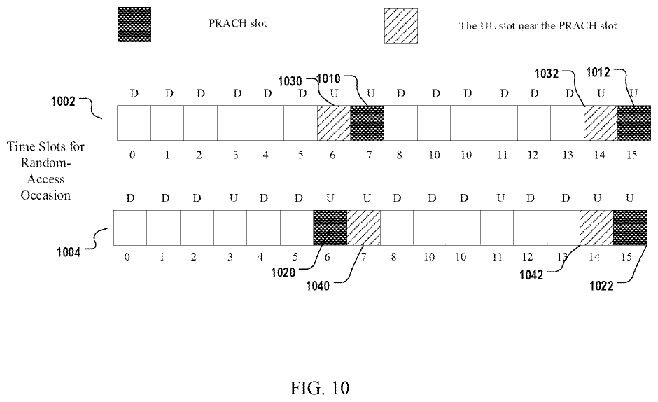

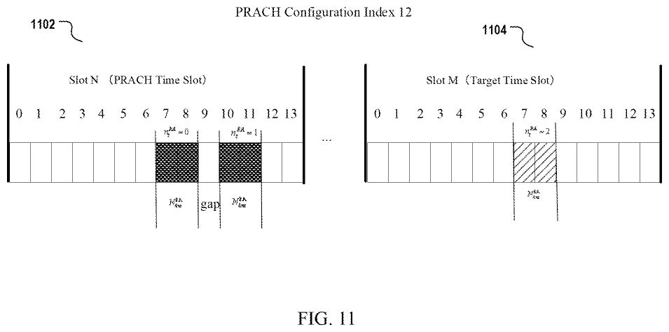

In another example rule set for target time slot selection and configuration, one of the nearest uplink time slots to the current PRACH time slot configured for carrying the random-access occasions may be designated as the target time slot. In some example implementations, the overflowing random-access occasions may be relocated to a nearest uplink time slot following the current PRACH time slot configured for carrying the random-access occasions, as shown in FIG. 8. Specifically, 802 shows an example sequence of time slots in which uplink time slots 810 and 812 may be originally allocated as PRACH time slots (the darker shaded time slots) to accommodate random-access occasions according to the PRACH mapping table. When random-access occasion(s) overflows as a result of the time gap insertion, the overflowing random-access occasion(s) may be reallocated or reconfigured to their nearest following uplink time slots 830 and 832 (the lighter shaded time slots). Letter “D” and “U” in FIG. 9 (and other figures in this disclosure) are used to designate “downlink” and “uplink”, respectively. The darker shaded time slots in FIG. 9 (and FIGS. 10-11) represent the originally allocated PRACH time slots whereas the lighter shaded time slots represent the target time slots for overflow of random-access occasions (the unshaded time slots are not allocated for random-access). Likewise, FIG. 8 further shows another example sequence of time slots 804 in which uplink time slots 820 and 822 may be originally allocated as PRACH time slots for accommodating random-access occasions according to the PRACH mapping table. When random-access occasion(s) overflows as a result of the time gap insertion, the overflowing random-access occasion(s) may be reallocated or reconfigured to their nearest following uplink time slots 840 and 842.

In some other example implementations, the overflowing random-access occasions may be relocated to a nearest uplink time slot preceding the current PRACH time slot configured for carrying the random-access occasions, as shown in FIG. 9. Specifically, 902 shows an example sequence of time slots in which uplink time slots 910 and 912 may be originally allocated as PRACH time slots for accommodating random-access occasions according to the PRACH mapping table. When random-access occasion(s) overflows as a result of the time gap insertion, the overflowing random-access occasion(s) may be reallocated or reconfigured to their nearest preceding uplink time slots 930 and 932. Likewise, FIG. 9 further shows another example sequence of time slots 904 in which uplink time slots 920 and 922 may be originally allocated as PRACH time slots for accommodating random-access occasions according to the PRACH mapping table. When random-access occasion(s) overflows as a result of the time gap insertion, the overflowing random-access occasion(s) may be reallocated or reconfigured to their nearest preceding uplink time slots 940 and 942.

In some other example implementations, the overflowing random-access occasions may be relocated to a nearest uplink time slot to the current PRACH time slot configured for carrying the random-access occasions, as shown in FIG. 10, regardless of whether it precedes or follows the current PRACH time slot. Specifically, 1002 shows an example sequence of time slots in which uplink time slots 1010 and 1012 may be originally allocated as PRACH time slots for accommodating random-access occasions according to the PRACH mapping table. When random-access occasion(s) overflows as a result of the time gap insertion, the overflowing random-access occasion(s) may be reallocated or reconfigured to their nearest uplink time slots 1030 and 1032, which happen to be preceding time slots. Likewise, FIG. 10 further shows another example sequence of time slots 1004 in which uplink time slots 1020 and 1022 may be originally allocated as PRACH time slots for accommodating random-access occasions according to the PRACH mapping table. When random-access occasion(s) overflows as a result of the time gap insertion, the overflowing random-access occasion(s) may be reallocated or reconfigured to their nearest uplink time slots 1040 and 1042. One of these time slots, time slot 1040 happens to be a following time slot of time slot 1020, whereas the other time slot 1042 happens to be a preceding time slot instead of time slot 1022.

In some implementations, one or more constraints for selecting the target time slot may be imposed in the rule set above. For example, a constraint may be imposed such that the target time slot for overflow is within the reference duration (e.g., time slot duration corresponding to 60 KHz SCS) from the actual PRACH time slot, or that the target time slot for overflow is within the reference duration that encompasses the actual PRACH time slot.

### Example Rule Set for Configuring Overflow Random-Access Occasion Symbols in a Target Time Slot

Once a first rule set for selecting the target time slots for overflowing random-access occasions (such as any of the example rule sets described above) is specified and a target time slot is identified accordingly, the overflow random-access occasion(s) may then be relocated or reconfigured to the target time slot. Symbol location of the overflow random-access occasion(s) within the target time slot and their indexing may be specified by a second rule set. Various example implementations of such a second rule set are described in further detail below, taking PRACH configuration indices 12 and 89 in the mapping table above as examples.

In some general implementations, the second rule set may include implicitly relocating or reconfiguring the overflow random-access occasion(s) corresponding to a PRACH configuration index into a target time slot at the entirety or subset of corresponding symbol locations as indicated by the parameters for the PRACH configuration index specified in the mapping table (alternatively referred to as target symbol positions). The required gap(s) may be further configured in the target time slot for determining the target symbol positions in the target time slot and as the overflow random-access occasions are relocated to the target time slot. The examples illustrated in FIGS. 11-16 follow such general rule set. In FIGS. 11-16, the time slots on the left 1102, 1202, 1302, 1402, 1502, and 1602 labeled as “Slot N” represent a PRACH time slot as configured according to the mapping table above. The time slots on the right 1104, 1204, 1304, 1404, 1504, and 1604 labeled as “Slot M” represent the target time slots corresponding to the PRACH time slots 1102, 1202, 1302, 1402, 1502, and 1602, respectively. The gap symbols that need to be configured are indicated by the label “gap”. The duration of each random-access occasion is assumed to be N_{dur}^{RA}=2 symbols. The target time slots 1104, 1204, 1304, 1404, 1504, and 1604 (“time slot M”) may be determined according to the example first rule set described above or other rule sets.

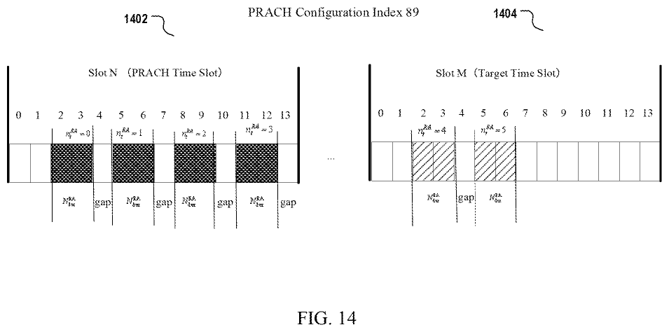

For example, in some implementations, the overflowing random-access occasions may be placed in the target time slot beginning at the starting symbol position as specified in the mapping table, as illustrated in FIGS. 11-13 for PRACH configuration index of 12 and in FIGS. 14-16 for PRACH configuration index of 89. Specifically, the start symbol position for the overflowing random-access occasion(s) in the target time slot is 7 and 2 for PRACH configuration index of 12 and 89, respectively.

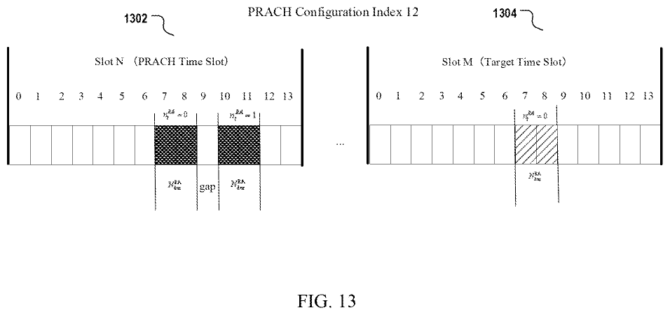

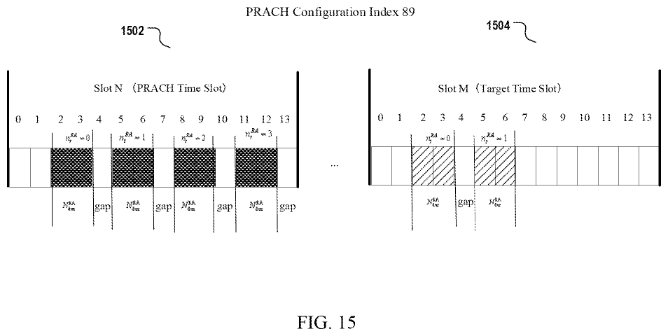

In some implementations, once all the overflowing random-access occasions are reallocated or reconfigured in the target time slot, the remaining symbol positions in the target time slot that may have been allocated for random-access occasions according to the mapping table but are no longer needed, if any, may be allocated for other use rather than for random-access occasions, as shown by FIG. 11 and FIG. 13 for PRACH configuration index of 12 and FIGS. 14 and 15 for PRACH configuration index of 89. In particular, as shown by FIGS. 11 and 13, once all three random-access occasions (as specified by the “Nₜ^{RA,slot}” parameter in the mapping table) are configured (two in the original PRACH time slot and one overflows to the target time slot for PRACH configuration index of 12), the remaining symbol positions 10 and 11 in the target time slot may not be reallocated to any random-access occasions. Likewise, under this example rule set, as shown by FIGS. 14 and 15, once all six random-access occasions (as specified by the “Nₜ^{RA,slot}” parameter in the mapping table for PRACH configuration index of 89) are configured (four in the original time slot and two overflow to the target time slot), the remaining symbol positions 8, 9, 11, and 12 (when the single-symbol gap is considered) in the target time slot may not be reallocated to any random-access occasions.

In some further implementations following FIGS. 11, 13, 14 and 15 described above, the overflowing random-access occasion(s) may be indexed in different manners. In some implementations, the overflowing random-access occasion(s) in the target time slot may be indexed continuously following the random-access occasions already indexed in the corresponding PRACH time slot, as shown in FIG. 11 for PRACH configuration index of 12 and FIG. 14 for PRACH configuration index of 89. For example, in FIG. 11, the three random-access occasions are indexed as nₜ^{RA}=0, 1, and 2 across from the current PRACH time slot into the target time slot. Similarly, in FIG. 14, the six random-access occasions are indexed as nₜ^{RA}=0, 1, 2, 3, 4, and 5 across from the current PRACH time slot into the target time slot.

In some other implementations, the overflow random-access occasion(s) in the target time slot may be indexed afresh in the target time slot, as shown in FIG. 13 for PRACH configuration index of 12 and FIG. 15 for PRACH configuration index of 89. For example, in FIG. 13, the two random-access occasions are indexed as nₜ^{RA}=0, 1 in the PRACH time slot and the refresh to nₜ^{RA}=0 in the target time slot for the third overflowing random-access occasion. Similarly, in FIG. 15, the four random-access occasions are indexed as nₜ^{RA}=0, 1, 2, and 3 in the current PRACH time slot and refresh to nₜ^{RA}=0, and 1 in the target time slot for the two overflowing random-access occasions.

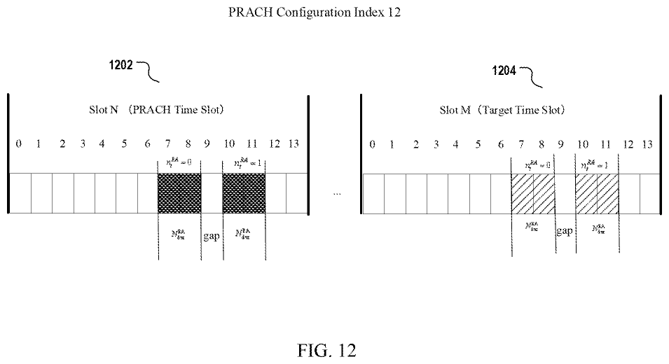

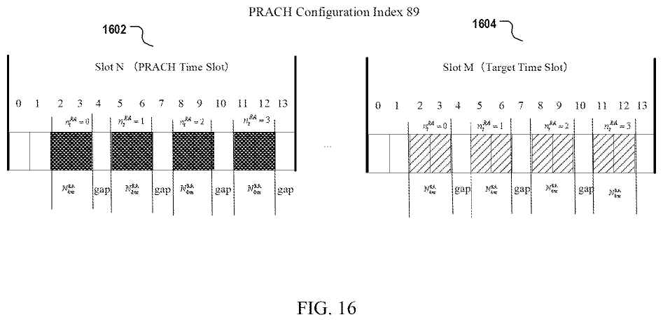

In some other implementations, distinct from the example implementations of FIGS. 11, 13, 14, and 15 described above, once all the overflow random-access occasions are reallocated in the target time slot, the remaining symbol positions in the target time slot that may have been allocated for random-access occasions according to the mapping table but are no longer needed, if any, may be allocated for additional random-access occasions, as shown by FIG. 12 for PRACH configuration index of 12 and FIG. 16 for PRACH configuration index of 89. In particular, as shown by FIG. 12, once all three random-access occasions (as specified by the “Nₜ^{RA,slot}” parameter in the mapping table) are configured (two in the original time slot and one overflows to the target time slot at symbol positions 7 and 8 for PRACH configuration index of 12), the remaining symbol positions 10 and 11 (after skipping gap symbol 9) in the target time slot may be reallocated to an additional random-access occasion. Likewise, under this example rule set, as shown by FIG. 16, once all six random-access occasions (as specified by the “Nₜ^{RA,slot}” parameter in the mapping table for PRACH configuration index of 89) are configured (four in the original time slot and two overflow to the target time slot at symbol positions 2-3 and 5-6), the remaining symbol positions 8, 9, 11, and 12 (with a gap symbol 10 in between) in the target time slot may be reallocated to additional random-access occasions.

Under the example rule set underlying the implementations of FIGS. 12 and 16, additional random-access occasions are configured in the target time slot to providing more optional resources for transmitting random access preamble. In both of these implementations, for example, the overflowing random-access occasion(s) from the PRACH time slot and the additional random-access occasions in the target time slot may be indexed afresh. For example, in FIG. 12, the single overflowing random-access occasion and the single additional random-access occasion for PRACH configuration index of 12 may be indexed as nₜ^{RA}=4=0, 1. For another example, in FIG. 16, the two overflowing random-access occasions and the two additional random-access occasions for PRACH configuration index of 89 may be indexed as nₜ^{RA}=0, 1, 2, and 3.

In some implementations, the time gaps apply to both PRACH time slot and the target time slot as shown in FIGS. 11-16, indicating the example single-symbol gap positions in both the PRACH time slot and in the target time slot.

### Signaling of Target Time Slot Configuration Rules and Random-Access Symbol Reconfiguration Rules

In some implementations, the rule set above for target time slot configuration and/or the rule set for random-access symbol reconfiguration within a target time slot may be predefined. As such, no additional signaling may be required for the UE to locate the random-access occasions within both the actual PRACH time slot and the target time slot(s).

In some other implementations, different options for the rule sets above may be specified, and the choice of an applicable target time slot configuration rule set and a random-access symbol reconfiguration rule set may be indicated by higher layer signaling. A UE may determine the rules sets by decoding the signaling and according apply the rule sets as defined when identifying random-access occasions for transmitting PRACH preambles. In some implementations, the optional rule sets may be indexed and the signaling may include one or more rule set indices only.

### Implementing the Target Time Slot Configuration Rule Set and Random-Access Symbol Reconfiguration Rules in UE and WANN

UE such as the ones shown in FIG. 2 may be configured to utilize the various rule sets described above to perform random-access configuration and communication. For example, The UE may be configured to receive a PRACH configuration information from a WANN. The PRACH configuration information may indicate a PRACH time slot and intra-time-slot symbol positions of a plurality of PRACH occasions within the PRACH time slot for transmitting a random-access preamble. The UE may be configured to further identify a target time slot according to, for example, a location of the PRACH time slot and a target time slot configuration rule set and relocating at least one of the plurality of PRACH occasions of the PRACH time slot to the target time slot.

Likewise, a WANN or base station such as the ones shown in FIG. 2 be configured to utilize the various rule sets described above to configure perform random-access communications with a UE. For example, the WANN may be configured to transmit PRACH configuration information to a wireless terminal device. The PRACH configuration information may indicate a PRACH time-slot and intra-time-slot symbol positions of a plurality of RACH occasions within a PRACH time slot corresponding to the PRACH time-slot position for transmitting a random-access preamble. The WANN may be configured to further identify an overflow condition of PRACH occasions. For a relocation of overflow PRACH occasions, the WANN may further identify a target time slot according to, for example, a location of the PRACH time slot and a target time slot configuration rule set, and identify a target symbol position within the target time slot according to, for example, the intra-time-slot symbol positions. The WANN may be additionally configured to receive a PRACH preamble from the wireless terminal device over the target symbol position in the target time slot under the overflow condition.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method performed by a wireless terminal device, comprising:
receiving a physical random-access channel (PRACH) configuration information from a base station or wireless access node, the PRACH configuration information indicating a PRACH time slot and intra-time-slot symbol positions of a plurality of PRACH occasions within the PRACH time slot for transmitting a random-access preamble;
identifying at least one target time slot;
relocating at least one of the plurality of PRACH occasions to the at least one target time slot.

2. The method of claim 1, wherein the at least one target time slot is identified according to a location of the PRACH time slot or is configured.

3. The method of claim 2, wherein the at least one target time slot is identified according to the location of the PRACH time slot by selecting a nearest uplink time slot following the PRACH time slot as the at least one target time slot.

4. The method of claim 2, wherein the at least one target time slot is identified according to the location of the PRACH time slot by selecting a nearest uplink time slot preceding the PRACH time slot as the at least one target time slot.

5. The method of claim 2, wherein the at least one target time slot is identified according to the location of the PRACH time slot by selecting a nearest uplink time slot relative to the PRACH time slot as the at least one target time slot.

6. The method of claim 2, wherein a location of the at least one target time slot is configured by a separate configuration information or by default specification.

7. The method of claim 1, wherein:
the at least one target time slot comprises at least one uplink time slot within a reference time duration determined by a reference subcarrier spacing.

8. The method of claim 7, wherein the reference time duration encompasses the PRACH time slot.

9. The method of claim 7, wherein the reference time duration comprises a reference time slot corresponding to the reference subcarrier spacing and is a multiple of the PRACH time slot.

10. The method of claim 9, wherein:
the reference subcarrier spacing is 60 kHz; and
the reference time duration comprises either a first set of time slots {0}, {1}, {2}, {3}, {4}, {5}, {6}, and {7} for 480 kHz PRACH subcarrier spacing or a second set of time slots {0}, {1}, {2}, {3}, {4}, {5}, {6}, {7}, {8}, {9}, {10}, {11}, {12}, {13}, {14} and {15} for 960 kHz PRACH subcarrier spacing.

11. The method of claim 9, wherein identifying the at least one target time slot comprises identifying N target time slots among multiple time slots within the reference time duration, wherein N is an integer equal to or greater than 1.

12. The method of claim 11, wherein:
N is greater than 1 and each of the at least one target time slot is associated with a priority for PRACH occasion relocation; and
PRACH occasions are relocated to a lower priority target time slot only after other higher priority target time slots among the at least one target time slot are used up for PRACH occasion relocation.

13. The method of claim 11, wherein a value of N and locations of the N target time slots within the reference time duration are predefined by default or configured using a separate configuration message or signaling information.

14. The method of claim 1, wherein the PRACH configuration information comprises a PRACH configuration index pre-mapped to a set of PRACH configuration parameters.

15. The method of claim 14, wherein the set of PRACH configuration parameters comprises:
a time slot position for the PRACH time slot;
a starting symbol position for the plurality of PRACH occasions within the PRACH time slot;
a number of PRACH occasions to be configured within the PRACH time slot; and
a duration of each of the plurality of PRACH occasions, and
the PRACH occasions are separate by at least one predefine gap symbol in time domain,
the at least one of the plurality of the PRACH occasions relocated to the at least one target time slot represents an overflow of PRACH occasions from the PRACH time slot.

16. (canceled)

17. (canceled)

18. The method of claim 15, where relocating the at least one of the plurality of PRACH occasions to the at least one target time slot comprises:
relocating the at least one of the plurality of PRACH occasions to the at least one target time slot at configured or default symbol positions within the at least one target time slot.

19. The method of claim 18, wherein the configured or default symbol positions in each of the at least one target time slot begin with the starting symbol position for the plurality of PRACH occasions as specified in the set of PRACH configuration parameters; or
a number of the configured or default target symbol positions in the at least one target time slot are greater then a number of PRACH occasions overflowing from the PRACH time slot, and extra target time symbol positions in the at least one target time slot beyond satisfying a need of the overflow PRACH occasions are repurposed for other uses or repurposed for additional PRACH occasions.

20. (canceled)

21. The method of claim 18, wherein the overflow PRACH occasions relocated to the at least one target time slot retain their PRACH occasion indices, or
the overflow PRACH occasions relocated to the at least one target time slot are assigned with PRACH indices afresh.

22. (canceled)

23. A method performed by a wireless access network node, comprising:
transmitting a physical random-access channel (PRACH) configuration information to a wireless terminal device, the PRACH configuration information indicating a PRACH time-slot and intra-time-slot symbol positions of a plurality of RACH occasions within the PRACH time slot for transmitting a random-access preamble;
identifying an overflow condition of PRACH occasions;
for a relocation of overflow PRACH occasions:
identifying at least one target time slot; and
identifying a target symbol position within the at least one target time slot; and
receiving a PRACH preamble from the wireless terminal device over the target symbol position in the at least one target time slot under the overflow condition.

24. The method of claim 23, wherein the at least one target time slot is identified according to a location of the PRACH time slot or is configured,
identifying the at least one target time slot comprises selecting at least one uplink time slot within a reference time duration determined by a reference subcarrier spacing,
the reference time duration encompasses the PRACH time slot; and the reference time duration comprises either a first set of time slots {0}, {1}, {2}, {3}, {4}, {5}, {6}, and {7} for 480 kHz PRACH subcarrier spacing or a second set of time slots {0}, {2}, {1}, {3}, {4}, {5}, {6}, {7}, {8}, {9}, {10}, {11}, {12}, {13}, {14} and {15} for 960 kHz PRACH subcarrier spacing,
identifying the at least one target time slot comprises identifying N target time slots, among multiple time slots within the reference time duration, wherein N is an integer equal to or greater than 1; and the value of N and locations of the N target time slots within the reference time duration are predefined by default,
N is greater then 1 and each of the at least one target time slot is associated with a priority for PRACH occasion relocation; and PRACH occasions are relocated to a lower priority target time slot only after other higher priority target time slots among the at least one target time slot are used up for PRACH occasion relocation.

25-38. (canceled)
